(19) United States
(12) Patent Application Publication
(10) Pub. No.: US 2014/0258003 A1
(43) Pub. Date: Sep. 11, 2014

(54) ONLINE ADVERTISING WITH INTEGRATED INTERFACES

(71) Applicant: MICROSOFT CORPORATION, Redmond, WA (US)

(72) Inventors: Sal Celis, Seattle, WA (US); Ian Ferreira, Issaquah, WA (US); Kris Shankar, Redmond, WA (US); Harpal Bassali, Kirkland, WA (US); Mark Ehrhardt, Seattle, WA (US); Stanislav Bounev, Seattle, WA (US); Stephen Giff, Bellevue, WA (US)

(73) Assignee: MICROSOFT CORPORATION, Redmond, WA (US)

(21) Appl. No.: 13/788,967

(22) Filed: Mar. 7, 2013

(51) Int. Cl. G06Q 30/02

(52) U.S. Cl. CPC G06Q 30/0277
USPC 705/14.73

(57) ABSTRACT

Various techniques for online advertising with integrated interfaces is disclosed herein. For example, a method can include detecting one or more display characteristics of an interface of a host application, generating an interface object for an advertisement item based on at least one of the detected display characteristics, and outputting the generated interface object as a portion of the interface of the host application.

### CROSS-REFERENCE TO RELATED APPLICATION(S)

This application is related to U.S. patent application Ser. No. 13/416,303, filed Mar. 9, 2012.

### BACKGROUND

Online advertising delivers marketing content to audiences via computer networks such as the Internet. For instance, web pages displaying search engine results may include banner and/or text advertisements for products or services. When users click on the displayed advertisements, the users may be redirected to third-party web pages based on web addresses embedded in the displayed advertisements.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present technology is directed to online advertising with integrated interfaces. In one aspect, the present technology includes detecting one or more display characteristics of an interface of a host application and generating interface objects for advertising items as an integral portion of the interface of the host application. As a result, the interface objects may have the same or a similar look and feel as the host application. In another aspect, the present technology is also directed to monitoring a change in at least one display characteristic of the host application. If a change is detected, the present technology includes adapting or adjusting the interface objects based on the detected change to maintain the same or similar look and feel as the host application.

In further aspects, the interface objects for advertising content can also enable users to obtain additional information for or even purchase advertised items within the host application. For instance, if a first input (e.g., cursor hovering) to an interface object is detected, an image, a supplier, and/or other information of the advertised item may be presented in the interface object. In another example, if a second input (e.g., a single click or touch) with respect to the interface object is detected, a new window may be displayed within the host application adjacent to the interface object. The window may include a title, a description, a price, a promotion, a link to a supplier's website, and/or other suitable additional information for the advertised item. In yet another example, the window may contain one or more fields for collecting payment, shipping, and/or other suitable information to facilitate a purchase of the advertised item.

### BRIEF DESCRIPTION OF THE DRAWINGS

FIG. 1 is a schematic diagram illustrating a computing framework in accordance with embodiments of the present technology.

FIG. 2 is a schematic block diagram illustrating computing components suitable for the information component of FIG. 1 in accordance with embodiments of the present technology.

FIG. 3 is a flow diagram illustrating a process for generating interface objects of advertising content in accordance with embodiments of the present technology.

FIG. 4 is a flow diagram illustrating a process of interacting with interface objects of advertising content in accordance with embodiments of the present technology.

FIGS. 5A-5F are example renderings of a host application having interface objects for presenting advertising content in accordance with embodiments of the present technology.

### DETAILED DESCRIPTION

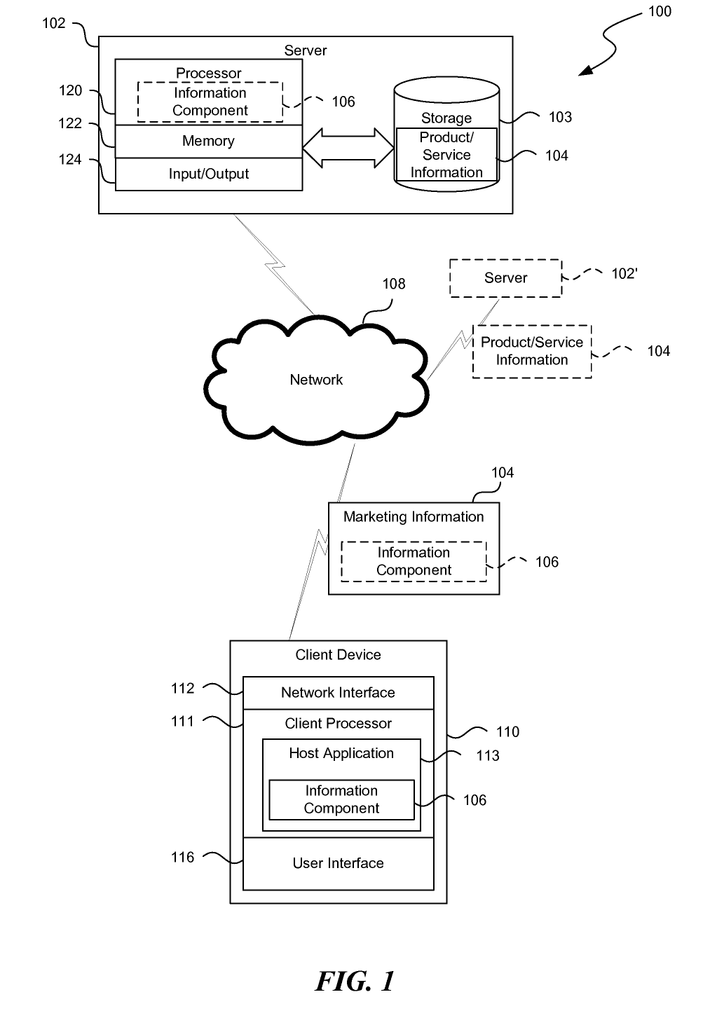

Various embodiments of systems, devices, components, modules, routines, and processes for online advertising with integrated interfaces are described below. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-5F.

As used herein, the term “interface object” generally refers to a graphical, textual, and/or other suitable types of representation of information on a user interface. For example, an interface object can include a graphical object having a background with a shape (e.g., rectangular), a color (e.g., gray) and a foreground having at least one of text, image, video, or other suitable types of content. The term “look and feel” generally refers to display characteristics of a user interface. The display characteristics can include at least one of a color, a shape, a layout, a typeface, and/or other design aspects (collectively referred to as “look”), as well as behaviors of at least one of a button, a box, a menu, and/or other functional elements (collectively referred to as “feel”).

Conventional advertising techniques may be ineffective because users tend to ignore the displayed advertisements. Users may also hesitate to click on the displayed advertisements for not knowing where the embedded web addresses may lead. Several embodiments of the present technology are directed to online advertising with integrated interfaces to improve user experiences. For example, in certain embodiments, interface objects containing advertising content can be configured to have the same or similar look and feel as a host application. As a result, the advertised content may be aesthetically more pleasant to use and thus less disruptive to user experiences than conventional online advertisements. It may also be easier for the advertised content to obtain information from users, and thus more in context with other information provided in the host application. In other embodiments, the interface objects can also provide different levels of preview of advertised content. As such, users may have more confidence that clicking through links associated with the advertised content has less risk of phishing, attacks, and/or other adverse consequences.

FIG. 1 is a schematic block diagram illustrating a computing framework 100 in accordance with embodiments of the present technology. As shown in FIG. 1, the computing framework 100 can include a server 102 and a client device 110 interconnected by a network 108. In other embodiments, the computing framework 100 can include an optional server 102′ (shown in phantom lines for clarity) that may be generally similar to or different than the server 102. In further embodiments, the computing framework 100 can include additional servers, client devices, networking devices, and/or other suitable components. The network 108 can be the Internet, a personal area network, a local area network, a storage area network, a backbone network, a metropolitan area network, a wide area network, a virtual private network, and/or other suitable types of network.

In the illustrated embodiment, the server 102 can be configured to provide product/service information 104, an email (not shown), and/or other suitable information to the client device 110. Even though the server 102 is illustrated in FIG. 1 as a single computing device, in certain embodiments, the server 102 may include one or more separate computing devices individually configured to perform at least one of the foregoing functions. For example, the server 102 can include one or more of an enterprise server (e.g., an Microsoft® Windows Server), a mail server (e.g., an Microsoft® Exchange Server), a web server, an advertising server, a communication server, and/or other suitable types of server. In other embodiments, the optional server 102′ and/or other suitable sources (not shown) may provide the product/service information 104.

As shown in FIG. 1, the server 102 can include a processor 120, a memory 122, an input/output component 124, and a storage 103 interconnected to one another. The processor 120 can include a mainframe processor, a microprocessor, a field-programmable gate array, and/or other suitable logic devices. The processor 120 can also include an optional advertising component 106 (shown in phantom lines), as described in more detail below. The memory 122 can include volatile and/or nonvolatile computer readable storage media (e.g., ROM, cache). The memory 122 can be configured to store data received from, as well as instructions for, the processor 120. The input/output component 124 can include a display, a touch screen, a keyboard, a track ball, and/or other suitable types of input/output devices configured to accept input from and/or provide output to a user and/or other computing components (not shown). The storage 103 can include magnetic disk storage media, optical storage media, flash memory drives, and/or other suitable computer readable storage media. As used herein, the term “computer readable storage medium” excludes propagated signals.

As shown in FIG. 1, the storage 103 of the server 102 can include a database that contains records of product/service information 104. In certain embodiments, the product/service information 104 can include advertising content (e.g., description, price, supplier of a product or service), promotions (e.g., on-sale information), availability information (e.g., product launch date), and/or other suitable information for a particular business entity. In other embodiments, the product/service information 104 can also include detailed descriptions, technical specifications, product/service reviews, and/or other information related to products or services. In yet other embodiments, the product/service information 104 can also include the foregoing and/or additional information for a plurality of business entities. For example, the product/service information 104 may be maintained on an advertising server and categorized based on keywords, class, time, and/or other suitable criteria. In any of the foregoing embodiments, the product/service information 104 may be organized in a structured or unstructured manner.

In certain embodiments, the client device 110 can include a desktop, a laptop, a tablet, a smartphone, and/or other suitable types of computing device. As shown in FIG. 1, the client device 110 can include a network interface 112, a client processor 111, and a user interface 116 interconnected to one another. Even though only the foregoing components of the client device 110 are shown in FIG. 1, in other embodiments, the client device 110 may also include other suitable hardware/software components.

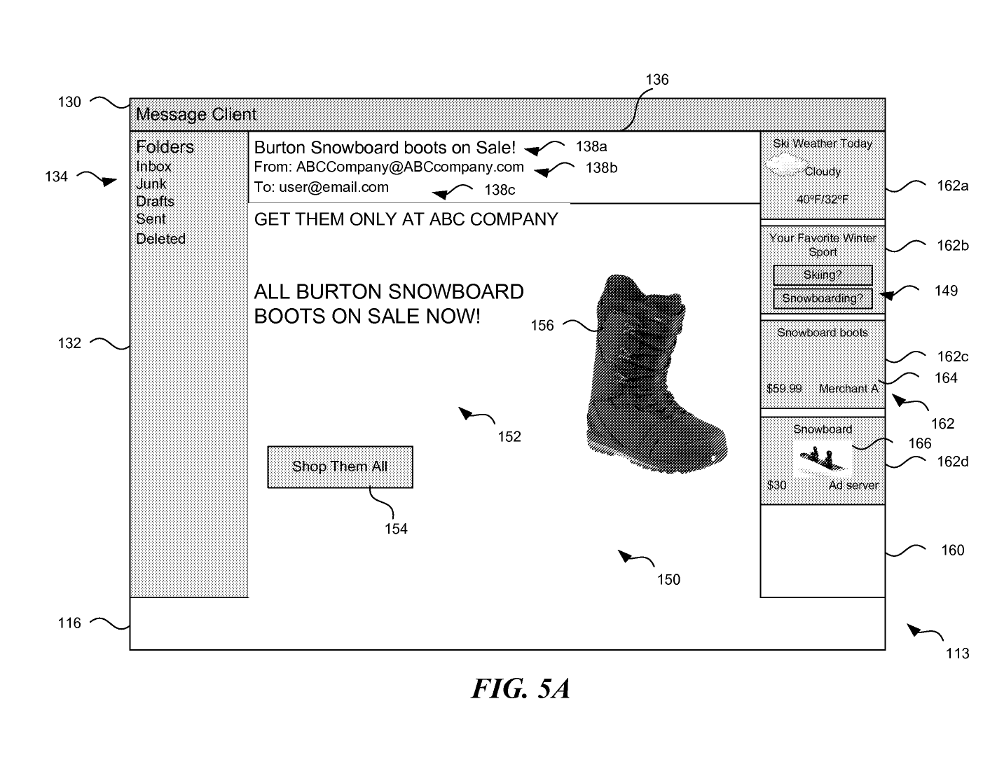

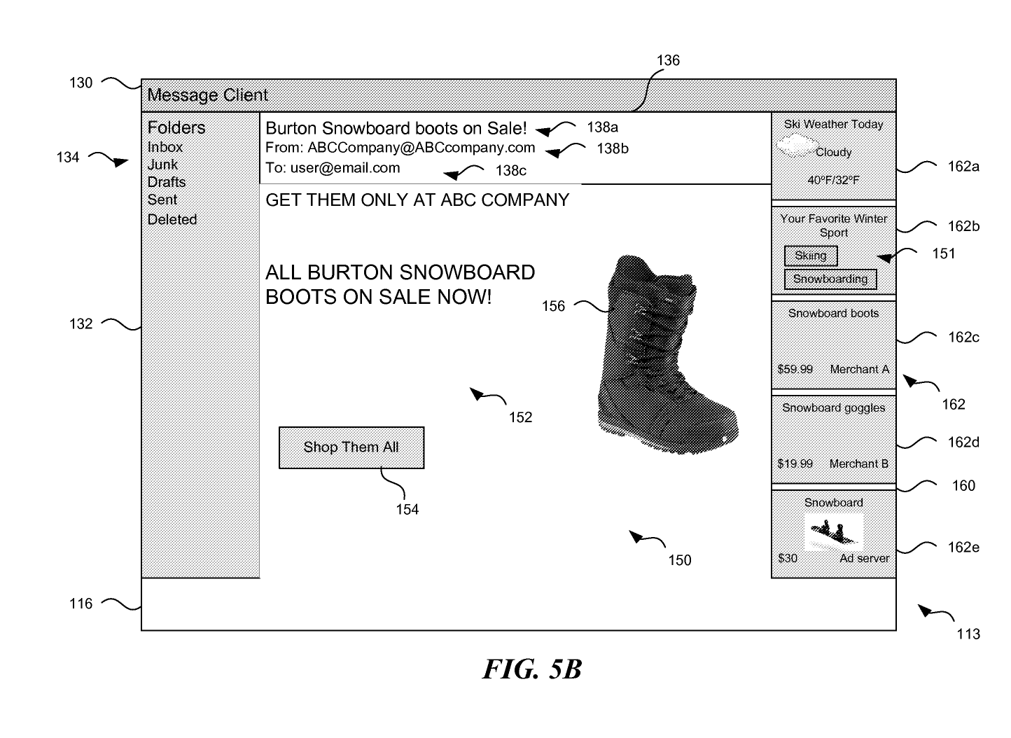

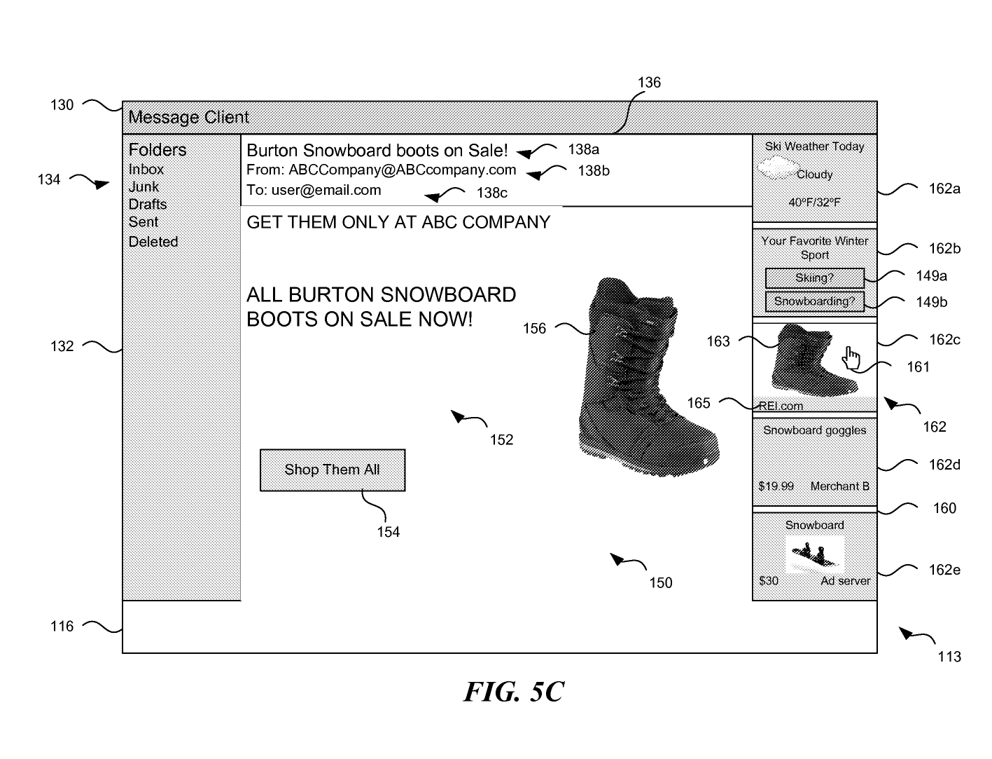

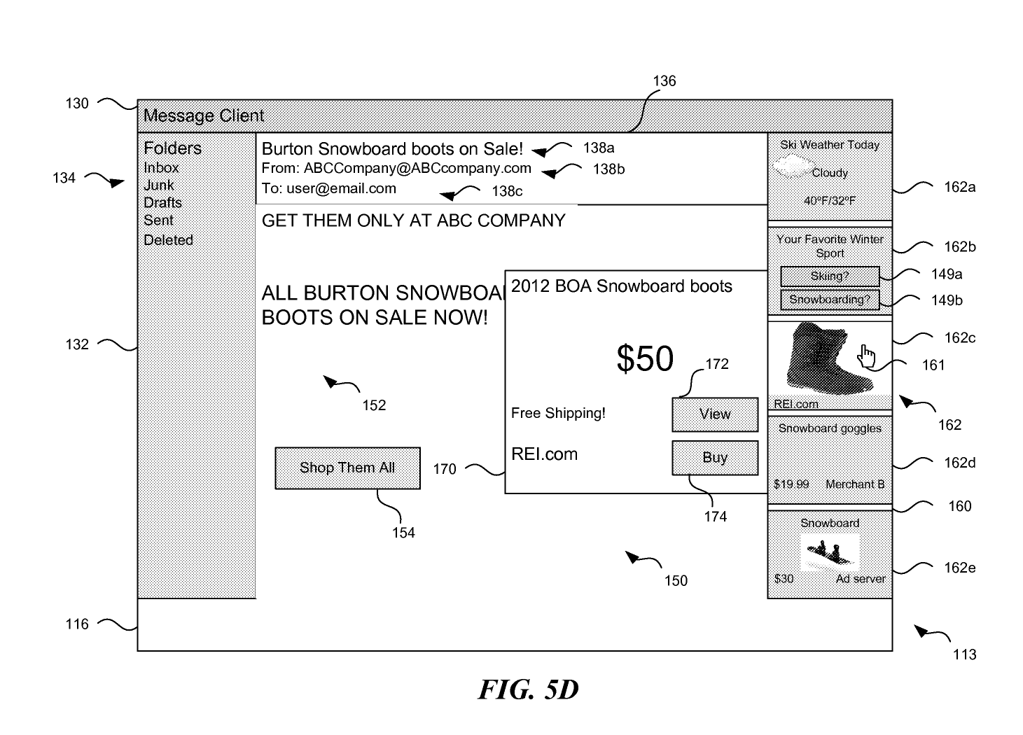

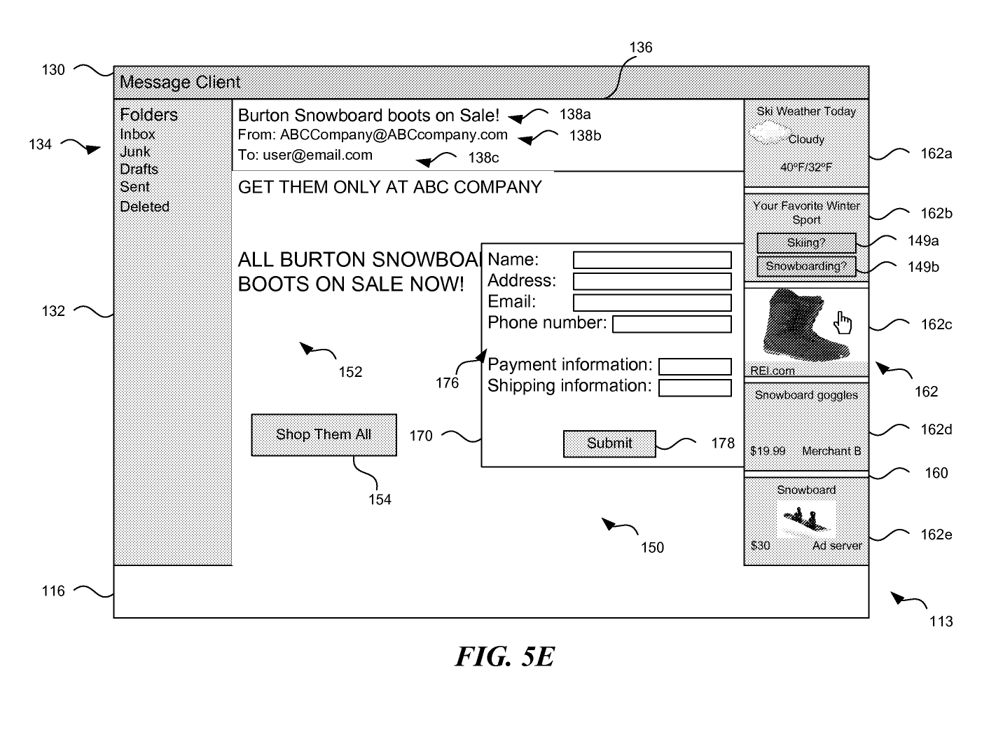

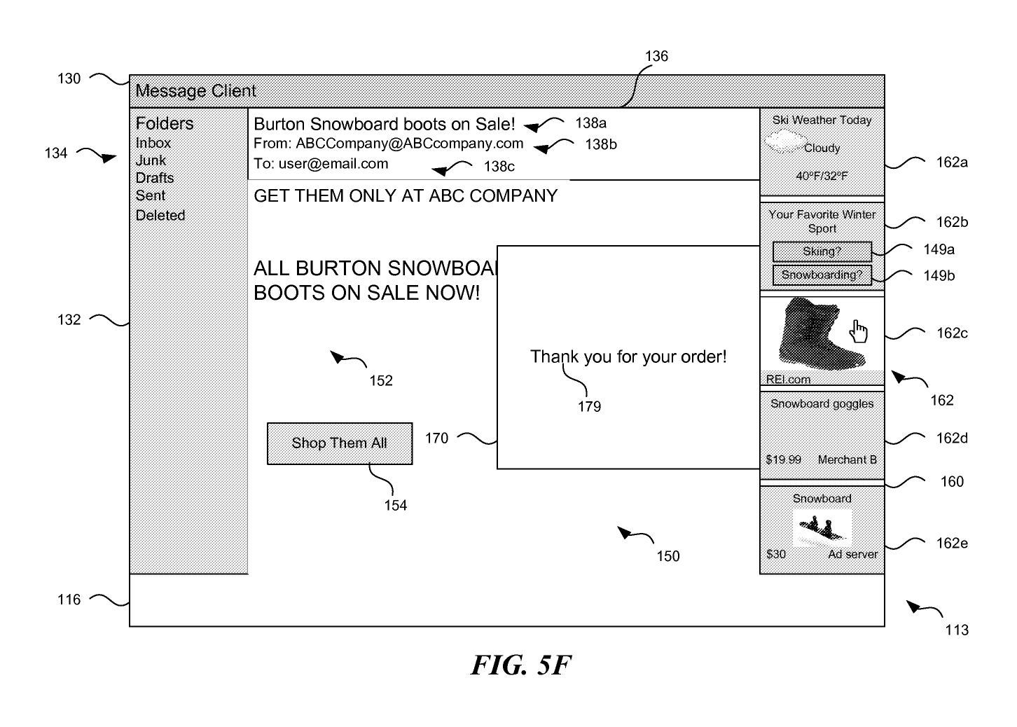

The client processor 111 can include a microprocessor, a field-programmable gate array, and/or other suitable logic devices configured to execute instructions of a host application 113. The host application 113 can include a client-based computer application (e.g., Microsoft Outlook®), a web-based computer application (e.g., Google Gmail®), and/or other suitable types of computer applications. The network interface 112 can include a network adapter, a wireless network interface controller, and/or other suitable hardware/software configured to connect the client device 110 to the server 102 via the network 108 or other suitable networks. The user interface 116 can include a display, a touch screen, a keyboard, a track ball, and/or other suitable types of input/output component configured to accept input from and/or provide output to a user. Example rendering of the host application on the user interface 116 are described later with reference to FIGS. 5A-5F.

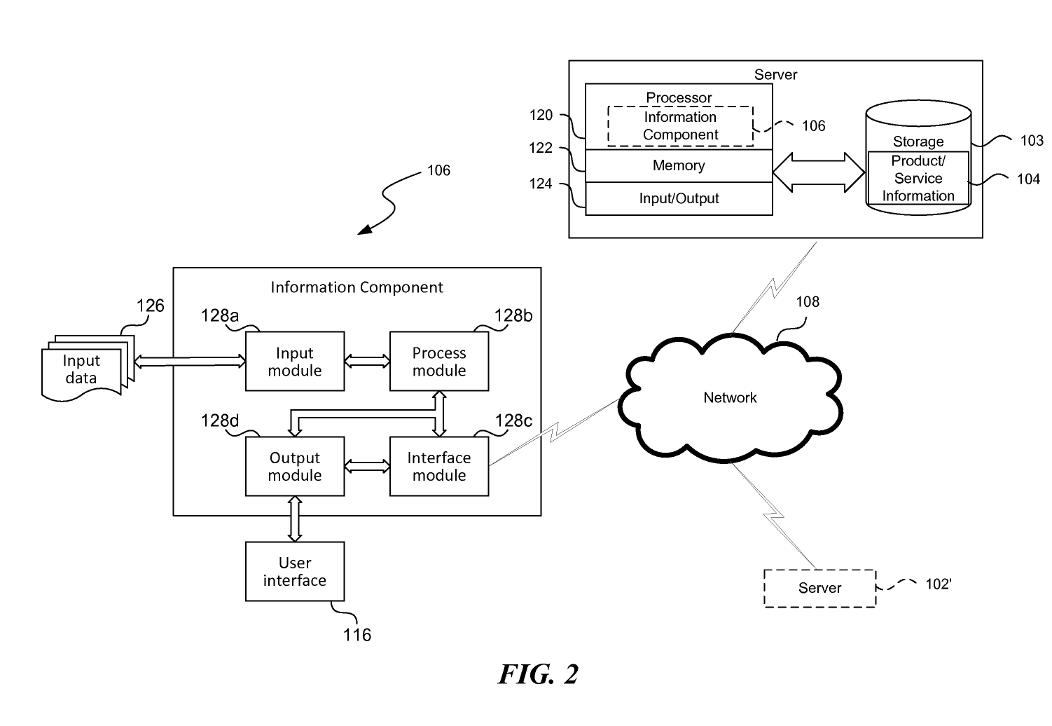

In the illustrated embodiment, the host application 113 includes an advertising component 106. In other embodiments, the advertising component 106 may be embedded in the product/service information 104, executed by the processor 120 of the server 102, and/or provided in other suitable manners. The information component 106 can be configured to generate interface objects of advertising content and/or other content based on at least one of display characteristics of the host application 113. As such, the generated interface objects can have the same or similar look and feel as the host application 113. In other embodiments, the information component 106 can also be configured to provide additional information of advertised items in the host application 113 in response to user input. In further embodiments, the information component 106 can be configured to facilitate purchase of advertised items in the host application 113. Various embodiments and operations of the information component 106 are described in more detail below with reference to FIG. 2.

FIG. 2 is a schematic block diagram illustrating computing modules suitable for the information component 106 of FIG. 1 in accordance with embodiments of the present technology. In FIG. 2 and in other Figures herein, individual software components, modules, and routines may be a computer program, procedure, or process written as source code in C, C++, Java, and/or other suitable programming languages. Various implementations of the source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 2, the information component 106 can include a detection module 128a, a process module 128b, a network module 128c, and an output module 128d interconnected with one other. Each of these modules 128a-128d may be a computer application, program, procedure, or routine written in a programming language, or one or more modules may be hardware modules. In certain embodiments, the modules 128a-128d may reside on the client device 110 as components of the host application 113 (FIG. 1). In another example, the modules 128a-128d may reside on the server 102 as components of a web-email application (not shown) executed by the server 102. In other embodiments, at least one of the modules 128a-128d may reside on the server 102 with the remaining residing on the client device 110. In further embodiments, at least one of the modules 128a-128d may be embedded in the product/service information 104 (FIG. 1), for example, as JavaScript components.

In one embodiment, the detection module 128a is configured to detect at least one display characteristic of an interface of the host application 113. For example, the detection module 128a may obtain and analyze a style sheet (e.g., a web style sheet) of the host application 113 (e.g., a web browser) as input data 126. The style sheet may indicate at least one of a font, a color, a size, a layout, an interactive behavior, a language setting, and/or other suitable display characteristics of the interface of the host application 113. In other examples, the detection module 128a may detect the at least one display characteristic based on user input, application design, and/or other suitable techniques. The process module 128b may be configured to analyze the detected at least one display characteristic and generate or update the interface objects for advertised items based on the at least one display characteristic. In one example, the process module 128b can generate the interface objects based on interface templates (not shown) residing on the server 102, the optional server 102′, the client device 110, or other suitable locations. The interface template can include at least one of a background, a title field, a price field, or an information source field, at least one of which has the same or similar display characteristics of the host application 113. In other examples, the process module 128b can generate the interface objects in other suitable manners. The output module 128d is configured to display the generated interface objects via the user interface 116.

Referring to both FIGS. 1 and 2, in operation, the host application 113 of the client device 110 can request product/service information 104 from the server 102. In response, the server 102 retrieves the product/service information 104 from the storage 103 and transmits the retrieved product/service information 104 to the client device 110 via the network 108. The product/service information 104 can include information for one or more advertised items.

In the illustrated embodiment, the detection module 128a of the information component 106 can detect at least one display characteristic of the interface of the host application 113. The process module 128b can then generate interface objects for individual advertised items contained in the product/service information 104 based on the detected at least one display characteristic. The process module 128b can also generate interface objects for non-advertising items (e.g., weather, poll, traffic, etc.) based on the detected at least one display characteristic. The output module 128d can then output the generated interface objects of the advertisement items to the user interface 116 as an integral portion of the interface of the host application 113 with the same or generally similar look and feel.

In another embodiment, instructions for the information component 106 may be embedded in the product/service information 104. Upon receiving the product/service information 104, the client processor 111 can then execute the instructions for the information component 106 to perform the foregoing operations. In yet another embodiment, the server 102 may be aware of the at least one display characteristic of the host application 113, for example, by receiving a prior or contemporaneous submission from the host application 113, or by executing instructions for the host application 113 as a web-based application. In response to the request for the advertising information, the processor 120 of the server 102 can execute instructions for the information component 106 and transmit the generated interface objects to the client device 110.

In certain embodiments, the detection module 128a can monitor for a change in the at least one of the display characteristics of the interface of the host application 113. For example, the interface of the host application 113 may have a new font, color, layout, interactive behavior, or language setting. In response, the process module 128b can adapt, adjust, or modify at least one of the generated interface objects based on the detected change. In another example, the detection module 128a may detect a size change (e.g., shrinking) in the interface of the host application 113. In response, the process module 128b can resize (e.g., reduce a size of) the generated interface objects based on the detected size change in the interface of the host application 113.

In further embodiments, the detection module 128a can monitor and collect certain input from a user as the input data 126. For example, the detection module 128a may monitor for a cursor hovering, a click, a tap, a touch, and/or other suitable user input to the displayed interface objects. In one embodiment, the process module 128b may analyze the collected user input and instruct the network module 128c and/or the output module 128d to perform other suitable operations based on the user input. For example, in one embodiment, the detection module 128a can detect a first input (e.g., a hovering of a cursor) with respect to one of the displayed interface objects. In response, the process module 128b identifies the first input and instructs the network module 128c to retrieve certain product/service information 104 (e.g., an image) from the server 102, the optional server 102′, and/or other suitable sources (not shown) via the network 108. The process module 128b can then instruct the output module 128d to output the retrieved additional information 104 in the interface object and/or other suitable locations in the host application 113.

In another embodiment, the detection module 128a can detect a second input (e.g., a single click) to one of the displayed interface objects. In response, the process module 128b identifies the second input and instructs the network module 128c to retrieve additional product/service information 104 (e.g., prices, images, videos, maps, etc.) from the server 102, the optional server 102′, and/or other suitable sources (not shown) via the network 108. The process module 128b can then instruct the output module 128d to output the retrieved additional information 104 in a window and/or other suitable locations in the host application 113.

In further embodiments, the detection module 128a can detect a user input to one of the interface objects not directed to advertising items. For example, the detection module 128a may detect a user's selection in response to a poll, a user's location selection for weather or traffic, and/or other suitable user input. In response, the process module 128b can analyze the detected user input and instruct the network module 128c to retrieve additional product/service information 104 based thereon. The process module 128b can then generate additional interface objects for the additional product/service information 104 and instruct the output module 128d to output the generated additional interface objects.

Several embodiments of the present technology can improve effectiveness of online advertising. It is believed that presenting the product/service information 104 in interface objects that have the same or similar look and feel as the host application can at least reduce the risk of users ignoring the product/service information 104. By providing various additional information for the advertised items within the host application 113, users can have more confidence on redirection from the host application 113 than conventional techniques.

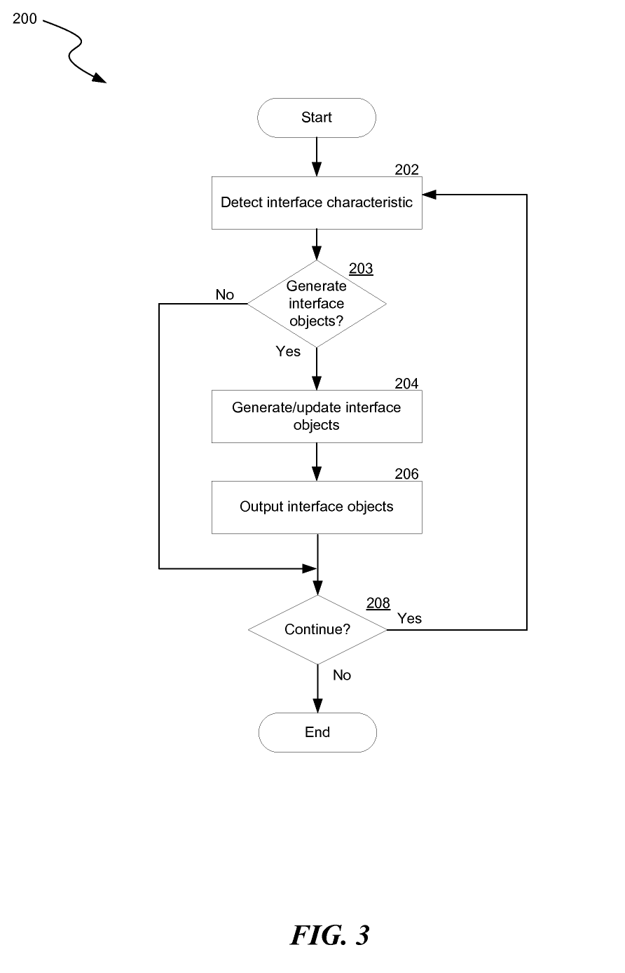

FIG. 3 is a flow diagram illustrating a process 200 for generating interface objects in accordance with embodiments of the present technology. Embodiments of the process 200 and other processes described herein may be performed on the server 102 (FIG. 1), the client device 110 (FIG. 1), and/or other suitable computing devices (not shown). Embodiments of the process 200 may also be embodied on an article of manufacture, e.g., as processor-readable instructions stored on a computer readable medium or be performed as a computer-implemented process, or in other suitable ways. Even though the process 200 is described below with reference to the computer framework 100 in FIG. 1, in other embodiments, embodiments of the process 200 can also be implemented in other suitable computer systems.

As shown in FIG. 3, the process 200 includes detecting one or more display characteristics of an interface of a host application at stage 202, for example, by the client processor 111 (FIG. 1). The display characteristics include at least one of a font, a color, a size, a layout, an interactive behavior, or a language setting of the interface of the host application. The process 200 can then include a decision at stage 203 to determine, for example, by the client processor 111, if interface objects are to be generated. In one embodiment, interface objects are generated if the detected one or more display characteristics indicate a change in at least one of the display characteristics. In another embodiment, interface objects may be generated if no interface objects are currently present. In further embodiments, interface objects may be generated based on other suitable criteria.

If interface objects are to be generated, the process 200 includes generating and/or updating interface objects at stage 204. In one embodiment, the interface objects may be generated based on a single interface template. In another embodiment, the interface objects may be generated based on multiple interface templates. As a result, at least two of the interface objects can differ from each other in at least one of content, font, color, size, layout, interactive behavior, language setting, and/or other suitable display characteristics. In further embodiments, the interface objects may be generated without using interface templates and/or using other suitable techniques. The process 200 can then include outputting the generated interface objects at stage 206. The process 200 then proceeds to stage 208 to determine if the process continues. In one embodiment, if the host application 113 (FIG. 1) is still active, the process 200 reverts to detecting the display characteristics at stage 202. In other embodiments, the process 200 may continue based on other suitable criteria.

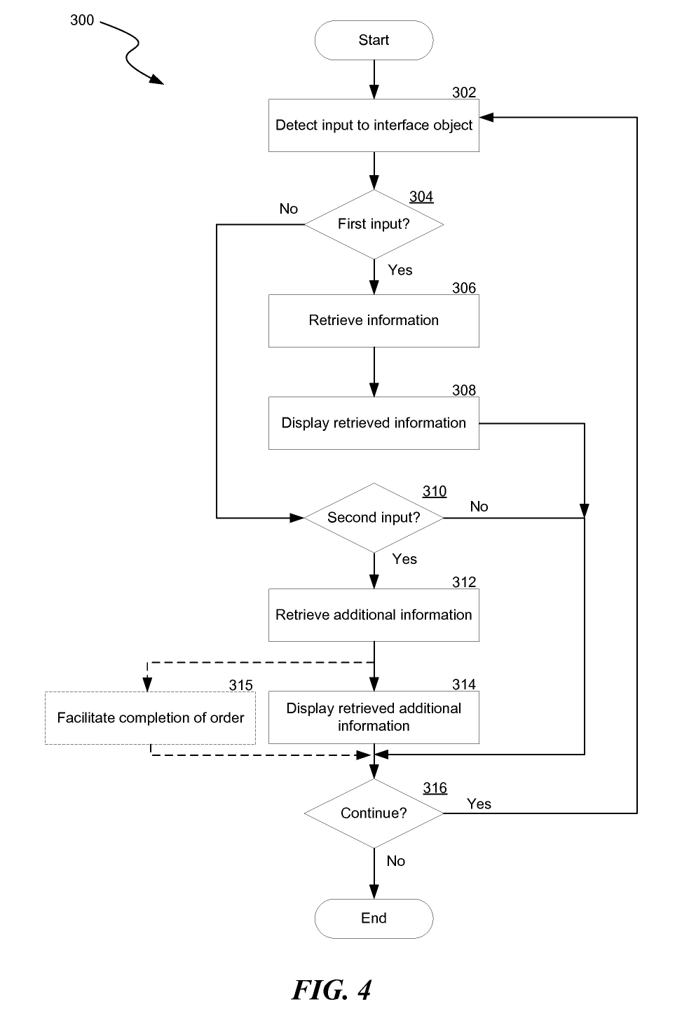

FIG. 4 is a flow diagram illustrating a process 300 of interacting with interface objects in accordance with embodiments of the present technology. As shown in FIG. 4, the process 300 includes detecting input to a displayed interface object at stage 302. The process 300 then includes a decision at stage 304 to determine if the detected input is a first input. The first input can be hovering of a cursor, a single click, a double click, and/or other suitable input. If the detected input is a first input, the process 300 proceeds to retrieving information of an advertisement item associated with the displayed interface object at stage 306. The information may be retrieved from an advertising server, a merchant's website, and/or other suitable sources. The retrieved information may include at least one of an image of the advertised item or a supplier the advertised item. The retrieved information may then be displayed at stage 308, for example, in the interface object or other suitable location.

If the detected input is not a first input, the process 300 proceeds to a decision stage 310 to determine if a second input is detected. The second input is different than the first input. The second input can be a single click, a double click, and/or other suitable input. If the detected input is a second input, the process 300 proceeds to retrieving additional information of the product or service associated with the displayed interface object at stage 312. The additional information may be retrieved from an advertising server, a merchant's website, and/or other suitable sources. The retrieved additional information includes at least one of a title, a description, a price, a promotion, or a link to the merchant's website.

The retrieved additional information may then be displayed at stage 314, for example, in a window in the host application 113 (FIG. 1) or other suitable location. In certain embodiments, the window may include at least one field for collecting order, payment, shipping information, and/or other suitable information. The process 300 may optionally include facilitating completion of order for the advertised item without exiting from the host application at stage 315.

If the detected input is neither the first input nor the second input, the process 300 then proceeds to stage 316 to determine if the process continues. In one embodiment, if the host application 113 (FIG. 1) is still active, the process 300 reverts to detecting user input at stage 302. In other embodiments, the process 200 may continue based on other suitable criteria.

Even though the process 300 is described above as having first and second input, in other embodiments, the process 300 may include third, fourth, or any other suitable number of input. In further embodiments, certain operations of the process 300 may be omitted. For example, in one embodiment, the decision stage 304 may be omitted, and the process 300 can include periodically retrieving the information of the advertised item at stage 306 and updating the interface object with the retrieved information at stage 308. In other embodiments, other operations of the process 300 may be omitted.

FIGS. 5A-5F are example renderings of the host application 113 having the information component 106 of FIG. 1 in accordance with embodiments of the present technology. In FIGS. 5A-5F, the host application 113 are shown as an email client with particular user interface arrangements for illustration purposes. In other embodiments, the host application 113 may also be other suitable types of applications and/or rendered according to other user interface arrangements.

As shown in FIG. 5A, the interface of the host application 113 on the user interface 116 can include a title bar 130 (e.g., “Message Client”), a first sidebar 132, a header bar 136, a body region 150, and a second sidebar 160. The first sidebar 132 includes a plurality of menu selections (e.g., “Folders,” “Inbox,” “Junk,” “Drafts,” “Sent,” and “Deleted”). The header bar 136 shows a subject 138a (i.e., “Burton Snowboard boots on Sale!”), an origination address 138b (i.e., “ABCCompany@ABCcompany.com”), and a destination address 138c (i.e., “user@email.com”). The body region 150 can include body text 152 (e.g., “GET THEM ONLY AT ABC COMPANY”), an image 156, a web link 154 to a website of the ABC Company, and/or other suitable components.

The second sidebar 160 includes a plurality of interface objects 162 (individually identified as first, second, third, and fourth interface object 162a-162d, respectively). As shown in FIG. 5A, the information component 106 can generate interface objects 162 that have the same or similar look and feel as the host application 113. For example, the third interface object 162c can have a background 164 that has the same color as the first side bar 132. The third interface object 162c can also have at least one of a title field (e.g., “Snowboard boots”), a price field (e.g., “$59.99”), or an information source field (e.g., “Merchant A”) over the background 164.

The interface objects 162 can differ in at least one of content, font, color, size, layout, interactive behavior, language setting, or other display characteristics. For example, as shown in FIG. 5A, the first interface object 162a includes non-advertising content (i.e., weather forecast). The second interface object 162b includes a poll (i.e., “skiing?” or “snowboarding”). Even though both the third and fourth interface objects 162c and 162d contain advertising content, the interface objects 162c and 162d may differ in other aspects. For example, the fourth interface object 162d includes a different layout than the third interface object 162c by having an image 166.

The interface objects 162 can also include be updated when a user interacts with the interface objects 162. For example, as shown in FIG. 5B, when a user takes the poll 149, the second interface object 162b may be updated to show poll results 151. In another embodiment, as shown in FIG. 5C, when the user hovers a cursor 161 over the third interface object 162c, the third interface object 162c is updated to show an image 163 and a web address 165 (“REI.com”) of the advertised item. In yet another embodiment, as shown in FIG. 5D, when the user clicks on the third interface object 162c, a pop-up or pop-out window 170 may be presented within the host application 113. In the illustrated embodiment, the window 170 can include a title (i.e., “2012 BOA Snowboard boots”), a price (i.e., “$50”), a description (i.e., “Free Shipping!”), and a web address (i.e., “REI.com”). The window can also include a “View” button 172 and/or a “Buy” button 174. If the user clicks on the “View” button 172, the user may be redirected to the merchant's website (i.e., “REI.com”).

As shown in FIG. 5E, if the user clicks on the “Buy” button 174, a plurality of input fields 176 may be presented in the window 170 as well as include a “Submit” button 178. For example, the input fields 176 can include fields to collect user, shipping, and payment information. In other examples, the window 170 may include additional and/or different input fields, buttons, selectors, or other suitable components. Once the user completes the input fields 176 and actuates the “Submit” button 178, the information component 106 can provide a confirmation 179 (i.e., “Thank you for your order!”) for the purchase in the window 170 and/or via other suitable channels, as shown in FIG. 5F.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A method of online advertising performed by a processor, the method comprising:
detecting one or more display characteristics of an interface of a host application;
generating an interface object for an advertisement item based on at least one of the detected one or more display characteristics; and
outputting the generated interface object for the advertisement item as a portion of the interface of the host application.

2. The method of claim 1 wherein the one or more display characteristics include at least one of a font, a color, a size, a layout, an interactive behavior, or a language setting of the interface of the host application.

3. The method of claim 1 wherein generating the interface object includes generating the interface object for the advertisement item based on the detected one or more display characteristics and an interface template containing at least one of a title field, a price field, or an information source field.

4. The method of claim 1 wherein:
generating the interface object includes generating the interface object for the advertisement item based on the detected one or more display characteristics and an interface template containing at least one of a title field, a price field, or an information source field; and
at least one of the title field, the price field, or the information source field has at least one of a font, a color, a size, a layout, an interactive behavior, or a language setting that is generally similar to that of the interface of the host application.

5. The method of claim 1 wherein:
generating the interface object includes generating the interface object for the advertisement item based on the detected one or more display characteristics and an interface template having a background and at least one of a title field, a price field, or an information source field over the background; and
at least one of the background, the title field, the price field, or the information source field has at least one of a font, a color, a size, a layout, an interactive behavior, or a language setting that is generally similar to that of the interface of the host application.

6. The method of claim 1, further comprising:
monitoring for a change in at least one of the display characteristics of the interface of the host application; and
if a change is detected, adapting the generated interface object based on the detected change in at least one of the display characteristics of the interface of the host application.

7. The method of claim 1, further comprising:
monitoring for a change in a size of the interface of the host application; and
if a change is detected, resizing the generated interface object based on the detected change in the size of the interface of the host application.

8. The method of claim 1, further comprising:
monitoring for a change in a size of the interface of the host application; and
if a change is detected, resizing the generated interface object based on the detected change in the size of the interface of the host application.

9. The method of claim 1, further comprising:
monitoring one or more input from a user to the host application; and
updating the generated interface object with a new advertisement item based on the monitored one or more input from the user.

10. A method of supplying product and/or service information performed by a processor, the method comprising:
generating first and second interface objects based on one or more display characteristics of an interface of a host application, the first interface object differs from the second interface object in at least one of content, font, color, size, layout, interactive behavior, or language setting; and
outputting the generated first and second interface objects as an integral portion of the interface of the host application, the first and second interface objects having a generally similar look and feel as the interface of the host application.

11. The method of claim 10 wherein the first interface object contains advertising content, and wherein the second interface content contains non-advertising content.

12. The method of claim 11 wherein the advertising content includes an advertising item, and the method further includes:
monitoring for a first input to the first interface object;
if a first input is detected,
retrieving information of an advertised item; and
updating the first interface object with the retrieved information.

13. The method of claim 11 wherein the advertising content includes an advertising item, and the method further includes:
periodically retrieving information of the advertised item; and
updating the first interface object with the retrieved information.

14. The method of claim 11 wherein the advertising content includes an advertising item, and the method further includes:
monitoring for a first input to the first interface object;
if a first input is detected,
retrieving information of the advertised item;
updating the first interface object with the retrieved information;
monitoring for a second input to the first interface object, the second input being different than the first input;
if a second input is detected,
retrieving additional information of the advertised item; and
displaying the retrieved additional information of the advertised item in the interface of the host application.

15. The method of claim 14 wherein:
monitoring for the first input includes monitoring for a hovering of a cursor over the first interface object; and
monitoring for the second input includes monitoring for a single click to the first interface object.

16. The method of claim 14 wherein:
the additional information includes at least one field for collecting order, payment, or shipping information; and
the method further includes facilitating completion of order for the advertised item without exiting from the host application.

17. The method of claim 14 wherein:
the retrieved information includes at least one of an image of the advertised item or a supplier the advertised item; and
the retrieved additional information includes at least one of a title, a description, a price, a promotion, or a link to the merchant's website.

18. A computer system for online advertising, the computer system having a processor operatively coupled to a memory and a display, the memory containing instructions, when executed by the processor, causing the processor to perform a process comprising:
detecting one or more display characteristics of an interface of a host application;
generating a plurality of interface objects based on one or more of the detected display characteristics of the interface of the host application and an interface template, the interface template having a background and at least one of a title field, a price field, or a source field over the background, at least one of the background, the title field, the price field, or the source field has at least one of a font, a color, a size, a layout, an interactive behavior, or a language setting generally similar to that of the interface of the host application; and
outputting the plurality of generated interface objects to the display as a sidebar in the interface of the host application.

19. The computer system of claim 18 wherein at least two of the interface objects differ in at least one of content, font, color, size, layout, interactive behavior, or language setting.

20. The computer system of claim 18 wherein:
at least one of the interface objects contains advertising content of an advertised item;
the processor further includes:
monitoring for a hovering of a cursor over the at least one of the interface objects;
if a hovering is detected,
retrieving information of the advertised item, the retrieved information including at least one of an image of a advertised item or a supplier of the advertised item;
updating the first interface object with the retrieved information;
monitoring for a click to the at least one of the interface objects;
if a click is detected,
retrieving additional information of the advertised item, the retrieved additional information including at least one of a title, a description, a price, a promotion, or a link to the merchant's website; and
displaying the retrieved additional information of the advertised item in the interface of the host application.
